(19) United States
(12) Patent Application Publication
(10) Pub. No.: US 2016/0205964 A1
(43) Pub. Date: Jul. 21, 2016

(54) MARSHMALLOW CANDY

(71) Applicant: John B. Tinius, JR., New Albany, IN (US)

(72) Inventor: John B. Tinius, JR., New Albany, IN (US)

(21) Appl. No.: 14/600,428

(22) Filed: Jan. 20, 2015

(51) Int. Cl. A23G 3/52; A23G 3/34

(52) U.S. Cl. CPC A23G 3/52; A23G 3/0019; A23G 3/0097; A23V 2002/00

(57) ABSTRACT

A marshmallow candy includes a marshmallow that has been dried or cooked to a taffy-like consistency. In the dried state, the marshmallow candy is sufficiently hard to the touch such that the marshmallow candy resists flexing when squeezed. The marshmallow candy then becomes chewy upon consumption. The marshmallow candy can be colored or shaped to be aesthetically pleasing for consumers.

### BACKGROUND

Marshmallows are a popular candy that has been enjoyed for many years. Traditionally, marshmallows are eaten while in a spongy consistency. However, it may be desirable to consume marshmallows in a taffy-like consistency.

### DETAILED DESCRIPTION

The following description of certain embodiments of the present disclosure should not be used to limit the scope of the present disclosure. Other examples, features, aspects, embodiments, and advantages of the invention will become apparent to those skilled in the art from the following description. As will be realized, various aspects of the present disclosure may take alternate forms, or have alternate or additional embodiments, without departing from the scope of the present disclosure. Accordingly, the drawings and descriptions should be regarded as illustrative in nature and not restrictive.

Marshmallow is a sugar candy that typically consists of sugar that is whipped to a spongy consistency. For instance, water, sugar, and corn syrup mix may be extruded or whipped in a first process to form the marshmallow. During this process, the marshmallow may be molded into small cylindrical pieces. Accordingly, the marshmallows are moist, fluffy, and easily squeezed.

The present disclosure relates to performing an additional second process of cooking or drying the marshmallow after the first process to form a marshmallow candy. For instance, the marshmallow can be exposed to a low level of heat for a predetermined amount of time to dry the marshmallow. This dehydrates the marshmallow to form a chewy and taffy-like candy, as opposed to the moist and fluffy marshmallow product after the first process. In this taffy-like consistency, the marshmallow candy is sufficiently hard to the touch such that the marshmallow candy resists flexing inwardly when squeezed. The marshmallow candy then becomes chewy when a consumer places the marshmallow candy in his mouth to moisten the marshmallow candy. A food dehydrator can be used to dry the marshmallow at about 130° F. for a period of about 10 to about 12 hours. Of course, other suitable methods of cooking or drying the marshmallow may be used, such as a conventional oven, a toaster oven, a microwave, etc. Other suitable methods of cooking or drying the marshmallow will be apparent to one with ordinary skill in the art in view of the teachings herein.

The marshmallow candy can include various shapes that are aesthetically pleasing, such as moons, ice cream cones, strawberries, cylinders, etc. These shapes can be formed during the first process, or after the second process of drying the marshmallow. The marshmallow candy can include different colors, such as pink, white, brown, yellow, etc. Each marshmallow candy may be a solid color, or each marshmallow candy may include multiple colors. These colors can be added during the first process, or after the second process of drying the marshmallow. Each marshmallow candy may further include various flavors, such as but not limited to, cherry, banana, raspberry, blueberry, chocolate, strawberry, lime, lemon, etc. Other suitable designs for the marshmallow candy will be apparent to one with ordinary skill in the art in view of the teachings herein.

It should be understood that any one or more of the teachings, expressions, embodiments, examples, etc. disclosed herein may be combined with any one or more of the other teachings, expressions, embodiments, examples, etc. that are disclosed herein. The teachings, expressions, embodiments, examples, etc. disclosed herein should therefore not be viewed in isolation relative to each other. Various suitable ways in which numerous aspects of the present disclosure may be combined will be readily apparent to those of ordinary skill in the art in view of the teachings disclosed herein. Such modifications and variations are intended to be included within the scope of both the present disclosure and the claims.

What is claimed is:

1. A method of making a marshmallow candy comprising drying a marshmallow to a taffy-like consistency.

2. The method of claim 1, comprising drying the marshmallow at a temperature of about 130° F.

3. The method of claim 2, comprising drying the marshmallow for a period of about 10 to about 12 hours.

4. The method of claim 1, comprising coloring the marshmallow candy.

5. The method of claim 4, wherein the marshmallow candy is a solid color.

6. The method of claim 4, wherein the marshmallow candy includes multiple colors.

7. The method of claim 4, wherein the marshmallow candy is colored prior to drying the marshmallow candy.

8. The method of claim 4, wherein the marshmallow candy is colored after drying the marshmallow candy.

9. The method of claim 1, comprising forming the marshmallow candy into an aesthetically pleasing shape.

10. The method of claim 9, wherein the marshmallow candy is shaped prior to drying the marshmallow candy.

11. The method of claim 9, wherein the marshmallow candy is shaped after drying the marshmallow candy.

12. The method of claim 1, comprising flavoring the marshmallow candy.

13. A marshmallow candy comprising a marshmallow having a taffy-like consistency.

14. The marshmallow candy of claim 13, wherein the marshmallow candy comprises a marshmallow dried at a temperature of about 130° F.

15. The marshmallow candy of claim 14, wherein the marshmallow candy comprises a marshmallow dried for a period of about 10 to about 12 hours.

16. The marshmallow candy of claim 13, wherein the marshmallow candy is colored.

17. The marshmallow candy of claim 16, wherein the marshmallow candy comprises a solid color.

18. The marshmallow candy of claim 16, wherein the marshmallow candy comprises multiple colors.

19. The marshmallow candy of claim 13, wherein the marshmallow candy comprises an aesthetically pleasing shape.

20. The marshmallow candy of claim 13, wherein the marshmallow candy is flavored.
